(19) United States
(12) Patent Application Publication
(10) Pub. No.: US 2007/0062006 A1
(43) Pub. Date: Mar. 22, 2007

(54) Ergonomic handle and handle sizing method

(76) Inventor: William Kendall Wright JR., Estacada, OR (US)

Correspondence Address: ANDREW L. DISCHER, 148 PALMER STREET, NE, GRAND RAPIDS, MI, 49505, US

(21) Appl. No.: 11/232,307

(22) Filed: Sep. 20, 2005

(51) Int. Cl. B25G 1/10

(52) U.S. Cl. 16/430

(57) ABSTRACT

A handle comprising a substantially flattened cylindrical body having an arching front surface, a substantially planar back surface, a top end and an axially opposed bottom end, a substantially ellipsoidal head is disposed on the top end, a neck is disposed between the head and the body, a substantially straight first side of the body, a second side of the body having an extended shoulder adjacent the neck, a carpal conformity is disposed on the front surface of the body substantially parallel to and adjacent the second side, and a leg disposed at the bottom end and projecting from the back surface.

### CROSS-REFERENCE TO RELATED APPLICATIONS

Not Applicable

### FEDERALLY SPONSORED RESEARCH

Not Applicable

### SEQUENCE LISTING OR PROGRAM LISTING

Not Applicable

### FIELD OF THE INVENTION

This invention relates generally to gripping handles. In particular, the invention relates to an ergonomic handle and handle sizing method used for reducing the possibility of carpal tunnel syndrome (CTS) and repetitive strain injuries (RSI).

### BACKGROUND OF THE INVENTION

Activities that involve repetitive use of the hands and wrists are common factors in the onset of CTS and other RSI. Injury or disease that compromises the ability of the legs and pelvis to support the body requires the use of orthopedic devices such as walkers, crutches and canes. These orthopedic devices use the hands, wrists and arms to support the body. The handle on most orthopedic devices is a portion of the frame or structure of the device which may or may not be covered by a soft material designed to prevent the hand from slipping and provide some measure of comfort.

These handles are functional but are not designed taking into account body mechanics. The handle on most orthopedic devices cause compression of the carpal tunnel and misalignment of the hand wrist and arm which puts tension on the tendons of the forearm. This tension leads to tendonitis and nerve damage in the arm. Furthermore, this misalignment increases tension that progresses throughout the connecting parts of the body placing stress on the arms, elbows, shoulders, neck, back, etc.

Patients who rely on orthopedic devices during recovery from injury often develop CTS, requiring additional surgery to correct the CTS.

Indentations for the fingers found on many handles have a tendency to bind the fingers and cause discomfort to the user. These indentations must be carefully sized for each unique user to prevent discomfort.

Soft coverings on many handles will decrease pressure on certain areas of the hand but are not designed to distribute the pressure to the areas that are most capable of sustaining it.

Handles have been proposed, for example in U.S. Pat. No. 5,339,850 to Mertz, U.S. Pat. No. 5,829,099 to Kopelman, and U.S. Pat. No. 6,530,125 B2 to Shippert, which include contoured surfaces designed to distribute pressure on the hand more effectively. These designs fail to engage the full supportive area of the hand in an attempt to prevent any pressure on the area adjacent the carpal tunnel. Additionally, none of the available designs take into account the natural angles of the hand and wrist in relation to the body. Furthermore, these handles are not adaptable to other devices being limited in the ability to properly mount the handle to accommodate the correct positioning of the hand.

CTS and RSI

The Carpal Tunnel is lined by the carpal bones on the posterior surface (backside) of the wrist, and the transverse carpal ligament is positioned on the anterior (front side) of the wrist. The size of the carpal tunnel is about the size of the index finger in diameter, and the flexor tendons, arteries and nerves are expected to glide past each other with ease within the carpal tunnel. But in such a small, confined space, there is little room for error. If the tendon size increases from inflammation or hypertrophy (growth), or if the carpal tunnel size decreases because the weak extensor muscles cannot withstand the tremendous pull from the flexor muscles, the carpal bones will shift downward and into the carpal tunnel.

Once the carpal bones have shifted downward and into the carpal tunnel, any form of repetitive flexion will cause friction of the flexor tendons against the carpal bones causing inflammation and irritation to the structures within the carpal tunnel. This domino effect causes the symptoms to continually increase until the pain and dysfunction of the hand becomes unbearable (carpal tunnel syndrome or a repetitive strain injury).

The onset of carpal tunnel syndrome symptoms is usually pain, numbness, paresthesia (pins and needle) and tingling in the fingers and hands; and there may be some swelling on the underside of the wrist. The hands will also become clumsy, weak and fatigue easily. Over time, this will cause a significant decrease in the ability to grasp small objects with precision control, and if left untreated, can lead to total dysfunction of the hand.

One of the most significant indicators of the onset of Carpal Tunnel Syndrome is awakening in the night with pain and numbness in the fingers and hands. Usually the individual has to sit up in bed and shake-out and/or rub the hands to get the circulation moving and decrease the carpal tunnel syndrome symptoms that they are experiencing.

Repetitive Strain injuries are slightly different in nature because they do not impair the function of the nerve. Repetitive Strain injuries can exhibit either vague or sharp pain, overall stiffness of the fingers hand, wrist and elbow, and the symptoms can affect both the front and backsides of the hands equally.

Boolean Voxel Method of Describing Complex Shapes

The Boolean Voxel Stream format provides a means of storing and exchanging geometric information using three-dimensional Boolean image volumes. The format is a simple, compact ASCII file that is designed to be human readable.

A solid object can be decomposed into a Boolean voxel representation. This representation is a simple 1-bit version of a volumetric medical scanner. An object is sampled into a series of small three dimensional cubes arranged on a regular grid. Each cube is classified as being inside or out of the solid object. Each cube has a known size given in real units, for example 1 mm×1 mm×1 mm. This allows the representation to maintain information about the size of the object.

The three-dimensional grid is referenced to a standard Cartesian coordinate system, with three orthogonal axes named x, y, and z. The cubes in the grid are referred to as voxels. The total space contained in the grid is referred to as the volume. All voxels in the grid have the same size, but a voxel does not have to have an equal size along each of the three axes. The size of one voxel is listed in the header of the file. Each voxel has a single value, either 1 (true) or 0 (false). If a voxel value is true, the center of the voxel is inside the solid object. If a voxel value is false, the center of the voxel is outside the solid object.

The boolean voxel steam file contains two parts, a header and a voxel stream. The header lists characteristics of the volume, including a format description, a size of a voxel, a size of the volume in terms of voxels, order that the voxels are listed in, and whether the stream is compressed or uncompressed. The voxel stream contains a list of the voxels in the format and order described in the header.
Header Format

The Boolean voxel stream file header includes 10 lines specified as follows:

Line 1—contains the text string “Boolean Voxel Stream 1.0”.

Line 2—contains a description of the person or software that generated the file.

Line 3—contains a description of the contents of the file.

Line 4—contains the text string “Voxel Size x y z”.

Line 5—contains three space delimited floating point numbers representing the size of a single voxel in the x-, y-, and z-directions.

Line 6—contains the text string “Volume Size x y z”.

Line 7—contains three space delimited integers representing the number of voxels in the x-, y-, and z-directions.

Line 8—contains the text string “Stream Order”.

Line 9—contains a space delimited list describing the order of the voxel stream. There are six possible combinations “x y z”, “x z y”, “y x z”, “y z x”, “z x y”, and “z y x”.

Line 10—contains a text string that says either “Compressed” or “Uncompressed”.
The Voxel Stream

All voxel values are listed in the order listed on Line 9 of the header. The voxel values can be listed in an uncompressed or compressed format. The compressed format is a run length compressed version of the uncompressed format.
Uncompressed Format

The uncompressed format contains a list of non-delimited voxel values either 0 or 1. An example of a fragment of a stream is given here:

0000011111111010000011100011100010100000011110001011010000100101
1111111111111100000000011111000011110000011110000000011111000011
1000 . . . etc.

Compressed Format

The compressed format is a run length compressed version of the uncompressed format. Each value represents the number of sequential false (0) or true (1) voxels in the stream. The stream must always begin with the number of zeros first. If the first voxel is true, a value of 0 must begin the list to say that there are no false voxels. The exemplary uncompressed stream fragment shown above is compressed here:

5 8 1 1 5 3 3 3 3 1 1 1 6 4 3 . . . etc.

The voxel values can be read into a three dimensional array representing the volume using nested “for loops”.

It is therefore desirable to provide a handle that overcomes the limitations, challenges, and obstacles described above.

### SUMMARY OF THE INVENTION

A handle comprising a substantially flattened cylindrical body having an arching front surface, a substantially planar back surface, a top end and an axially opposed bottom end, a substantially ellipsoidal head is disposed on the top end, a neck is disposed between the head and the body, a substantially straight first side of the body, a second side of the body having an extended shoulder adjacent the neck, a carpal conformity is disposed on the front surface of the body substantially parallel to and adjacent the second side, and a leg disposed at the bottom end and projecting from the back surface.

A handle coupled to an orthopedic device comprising a weight supporting front surface including a carpal conformity, wherein support pressure is minimized at a superior portion of a palm of a hand, a smooth finger contacting back surface comprising a lifting surface for lifting the handle and the coupled orthopedic device, a top end including a head wherein the head prevents sliding of the hand off the top end; and a bottom end including a leg wherein the leg prevents sliding of the hand off the bottom end.

A method for sizing a handle having standard dimensions comprising, determining critical hand dimensions, determining a scaling factor based on the critical hand dimensions and the standard dimensions, providing a Boolean voxel representation of the handle, where the Boolean voxel representation contains a plurality of volume values, and applying the scaling factor to the volume values of the Boolean voxel representation.

The aforementioned and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates a first side view if one embodiment of a handle, in accordance with the present invention;

FIG. 2 illustrates a front view if one embodiment of a handle, in accordance with the present invention;

FIG. 3 illustrates a second side view if one embodiment of a handle, in accordance with the present invention;

FIG. 4 illustrates a back view if one embodiment of a handle, in accordance with the present invention;

FIG. 5 illustrates a hand gripping one embodiment of a handle in accordance with one embodiment of the invention;

FIG. 6 illustrates a hand gripping one embodiment of a handle in accordance with one embodiment of the invention;

FIG. 7 illustrates a top view of one embodiment of a handle connected to an orthopedic device, in accordance with the present invention;

FIG. 8 illustrates a side view of one embodiment of a handle connected to an orthopedic device, in accordance with the present invention;

FIG. 9 illustrates one embodiment of a mounting bracket, in accordance with one embodiment of the present invention.

FIG. 10 illustrates an alternate embodiment of a handle connected to an orthopedic device, in accordance with the present invention;

FIG. 11 illustrates one embodiment of a handle connected to an operational device, in accordance with the present invention; and

FIG. 12 shows a boolean voxel stream file representing one embodiment of the handle in accordance with the present invention.

FIG. 13 illustrates a flowchart representative of one embodiment of a method for sizing the handle, in accordance with the present invention.

### DETAILED DESCRIPTION OF THE PRESENTLY PREFERRED EMBODIMENTS

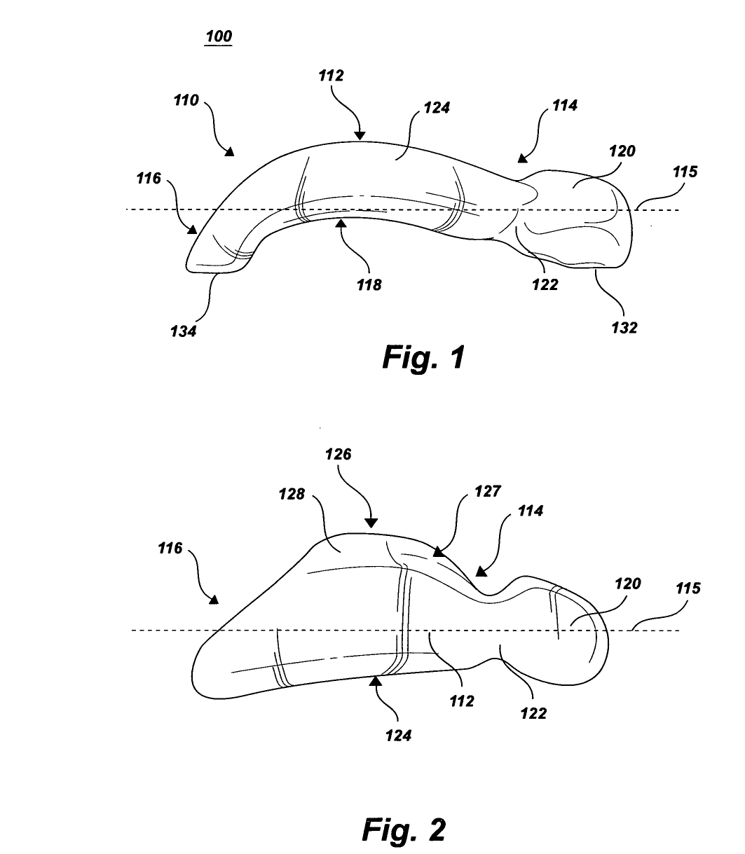

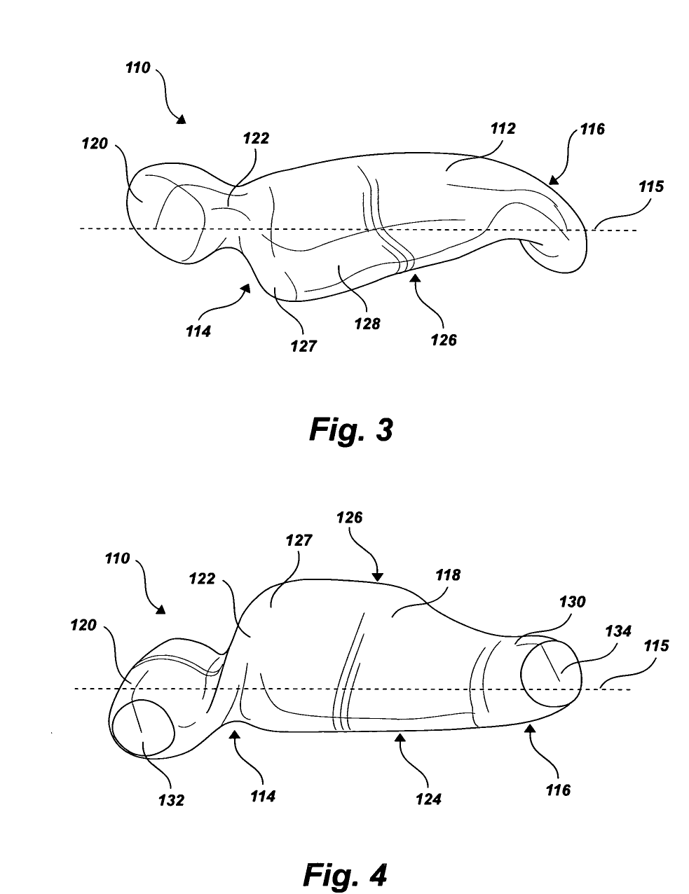

FIGS. 1 through 4 illustrate various views of a handle, in accordance with one embodiment of the present invention. The handle 100 comprises a body 110 having a profile resembling a flattened cylinder that is bowed so that a front surface 112 arches from a top end 114 of the body 110 to a bottom end 116 of the body. The top end 114 and bottom end 116 are at axially opposed locations along a center axis 115 through body 110. The body 110 is arched such that all extents of the handle are not equidistance from the center axis 115. The flattened cylindrical shape of body 110 defines a back surface 118 that is smooth and approximately flat.

A head 120 having a substantially ellipsoidal shape is situated at the top end 114 of the body 110. A neck 122 connects the head and the body and forms a slightly spiraling channel that accommodates the thumb and forefinger. A first side 124 of the body is straight from the top end to the bottom end. A second side 126 has a wide shoulder 127 at the neck and tapers slightly as it progresses toward the bottom end. A carpal conformity 128, which is an area of the handle having a reduced thickness in the dimension perpendicular to center axis 115, is formed in the front surface and extends the length of the second side. The carpal conformity comprises a structure resembling a folded wing. A leg 130 projects from the back surface of the body prevents the hand from sliding off the bottom end of the handle. Leg 130 is contiguous with body 110 such that arching front surface 112 transitions to the leg at bottom end 116 without any discontinuity. An upper flattened section 132 is disposed on head 120 and a lower flattened section 134 is disposed on the leg 130 and both are provided for attachment of the handle to a device.

Handle 100 is preferably formed using a molded thermo-set plastic, but any suitable material suitable, such as wood, nylon, or a metal can be used. A combination of materials that enhances various characteristics of the handle, such as comfort, strength, or durability can also be used. Material selection is dependent on a multitude of factors including production efficiency, manufacturing yield, comfort, durability, strength, and appearance.

The handle illustrated in the preceding discussion and the discussion that follows accommodates the right hand. The left-handed handle is a mirror image of the right-hand handle and offers the same function and advantages as the right-handed handle.

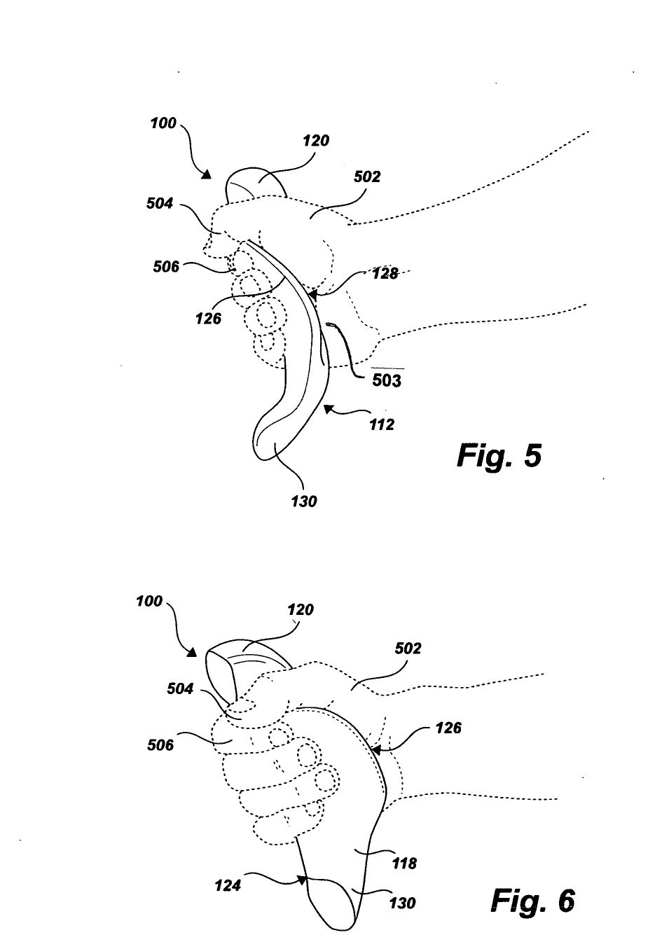

FIG. 5 and FIG. 6 illustrate a hand 502 gripping handle 100 in accordance with one embodiment of the invention. The essential characteristics of the handle that enhance the relationship between the hand and the handle are a surface that accommodates the various areas of the hand thereby allowing the entire palm to support downward or pushing forces while reducing pressure on the area of the carpal tunnel. Finger placement is optimized to facilitate a lifting or pulling of the handle without binding of the fingers.

Carpal conformity 128 accommodates and cradles the superior portion of the palm 503 at the location of the transverse carpal ligament adjacent the wrist. Carpal conformity 128 is of sufficient size to accommodate the entire superior portion of the palm of the hand and can be custom sized for any hand size. The metacarpal region of the palm is placed in contact with the balance of the front surface 112. The front surface supports the weight of a user's body through the palm, wrist, and arms of the user. The fingers flex around the first side 124 and contact the back surface 118. The finger and thumb comfortably wrap around approximately ⅔ of the handle facilitating lifting of the handle along with any attached device.

The thumb and index finger engage the neck 122. The thumb flexes adjacent the second side 126 while the index finger flexes adjacent the first side 124. The neck 122 spirals slightly around the body to prevent the thumb and index finger from overlapping on the back surface. The index finger resides toward the bottom end in relation to the thumb. Head 120 acts to ensure the thumb and index finger, through the saddle joint of the thumb, remains in contact with the neck 122 and prevents the hand 502 from slipping off the top end 114 of the body 110. In addition the thenar muscles located at the base of the thumb and the thumb itself assist the other areas of the palm in supporting the hand. Leg 130 prevents the fingers from slipping off the bottom end of body 110 while also providing a mounting location for handle 100.

With the hand properly placed on the handle downward pressure from the hand is supported by the entire contoured surface of front surface 102 that is in contact with the full surface of the palm. The weight of the user is primarily supported by the metacarpal region of the palm, the thumb and the thenar muscles at the base of the thumb. A compressive force at superior portion of the palm 503 that is in contact with carpal conformity 128 is minimized by the cradling action of the carpal conformity when handle 100 is properly positioned. Carpal conformity 128 cradles this area while still maintaining contact. The contact provided enables the superior portion of the palm to participate in controlling the movement of handle 100 and any attached device without being a primary weight supporting structure. Handle 100, as positioned, facilitates the transfer of vertical forces incident on the hand to the bones and muscles of the arm maintaining proper mechanical alignment of the various extensor, flexor, and abductor muscles within the arm.

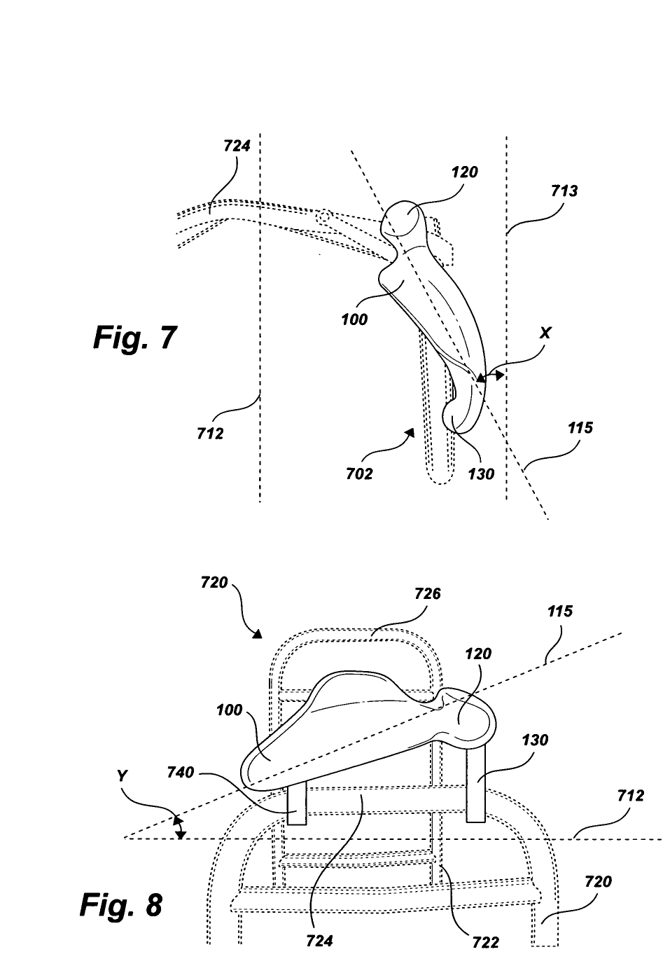

FIG. 7 and 8 illustrate one embodiment of a handle connected to an orthopedic device, in accordance with the present invention. The orthopedic device shown is a walker 702 but other orthopedic devices such as crutches or canes may be used. In addition, different styles of walkers are available for which the handle may be adapted. Walker 702 is a typical walker that is comprised of a tubular metal frame 710.

Walker 702 has a horizontal centerline 712, which also corresponds to the direction of forward movement of the walker. The metal frame 710 has a right side unit 720 and a left side unit 722 which are substantially identical and are generally rectangular in shape. A cross member 724 perpendicular to the horizontal centerline 712 connects right side unit 720 and left side unit 722 to form a generally U-shaped walker 702. A user stands inside the U- shaped area of walker 702 and grasps the each of the two side units at corresponding right upper section 724 and left upper section 726, both of which are generally parallel to the horizontal centerline 712. The relationship of handle 100 to the side units is substantially identical on both the right and left side. Description and illustration is made with reference to the right side.

A Connecting means, such as a front bracket 730 and a rear bracket 740, connect the handle 100 to the right upper section 724 of walker 702. The front bracket 730 is positioned at the head 120 and the rear bracket 740 is positioned at the leg 130 of handle 100. Front bracket 730 and rear bracket 740 are substantially identical and provide flexibility in the mounting location of handle 100 and the position of the handle in relation to the right upper section 724 of right side unit 720. Handle 100 is shown positioned in the optimal ergonomic position based on the natural alignment of the hand with respect to the wrist and body. Proper alignment of the hand with the wrist and body allows transmission of compressive and tensile stresses through the wrist and hand without producing compression of the transverse carpal ligament. Additionally proper alignment reduces tension on the tendons of the forearm, decreasing the likelihood of tendonitis and nerve damage at the elbow.

Proper alignment of handle 100 is illustrated in FIG. 7 and FIG. 8 with reference to a first angle X in FIG. 7 and a second angle Y in FIG. 8. First angle X is measured from centerline 115 of handle 100 to a line 713 parallel to horizontal centerline 712. Head 120 of handle 100 is rotated toward horizontal centerline 712, so that first angle X is approximately 20 degrees. Angle X conforms to the natural rotation of the human hand while at rest in relation to the forward movement of the body.

The handle is further positioned, as shown in FIG. 8, to provide a thumb high position of the hand which conforms to the position of the hand while at rest. To achieve this orientation, the top surface of the handle is sloped upwards, from rear bracket 740 to front bracket 730, at second angle Y of approximately 7 degrees. Angle Y is measured from centerline 115 to horizontal centerline 712 in the plane of right side unit 720.

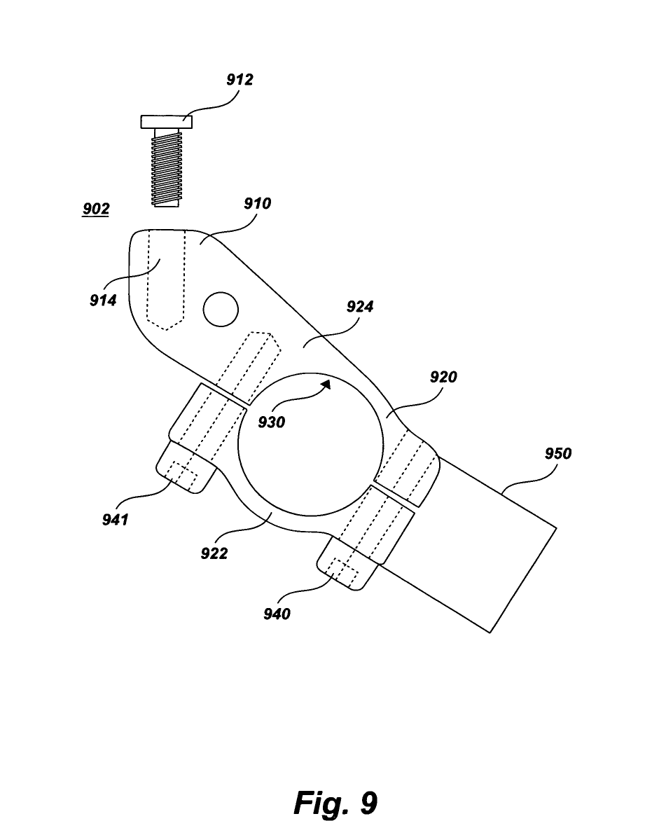

FIG. 9 illustrates one embodiment of a mounting bracket 902, in accordance with one embodiment of the present invention. Mounting bracket 902 includes a handle mount 910 and a device mount 920. Handle mount 910 includes a retaining device such as screw 912 that is inserted through a hole in the handle (not shown) and engages a threaded hole 914 in handle mount 910. In one embodiment, handle mount 910 includes a screw 912 inserted through a hole in the handle mount and engaging a threaded hole in the handle. The handle mount 910 can include other retaining devices or mechanical fasteners such as pins, bolts, rivets, rods, and studs. In another embodiment, screw 912 is replaced with an adhesive fastener such as an epoxy, or polyurethane adhesive.

The device mount 920 is a two part clamp having an upper clamp part 924 and a lower clamp part 922. Device mount 920 has an appropriate inner profile 930 to accommodate the tubing or frame of the walker (not shown). Device mount 920 is placed around the tubing or frame walker (not shown) and secured by tightening a first clamp bolt 940 and a second clamp bolt 941. First clamp bolt 940 and second clamp bolt 941 secures lower clamp part 922 to upper clamp part 924.

In one embodiment, mounting bracket 902 is an integral part of the handle and is formed of the same material as the handle.

The orientation of the handle in relation to the walker is modified by adjusting the location of the mounting bracket 902 on the walker or by using an adjustment screw 950. Adjustment screw 950 allows the handle to pivot or swivel while connected to the walker.

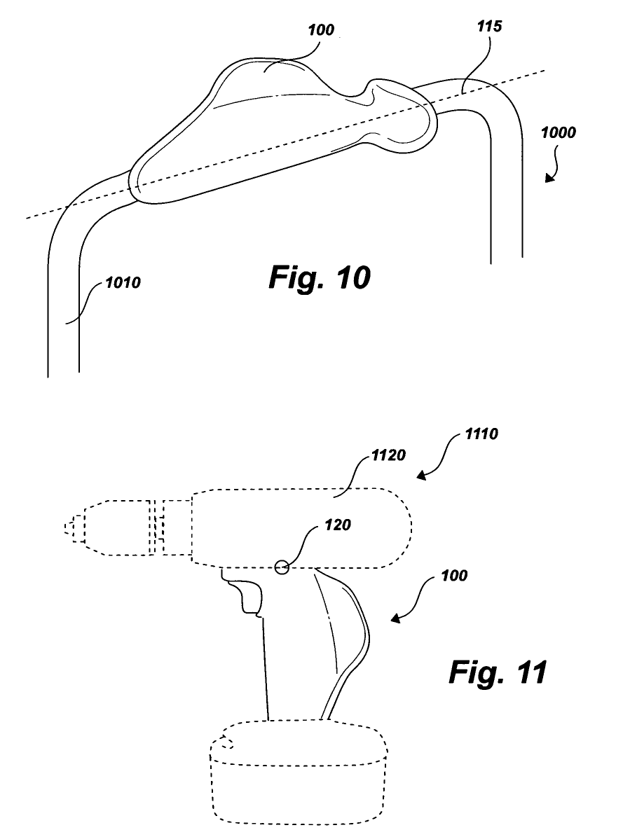

FIG. 10 illustrates an alternate embodiment of a handle connected to an orthopedic device, in accordance with the present invention. Orthopedic device 1000 includes a handle section 1010. Handle section 1010 is a portion of the orthopedic device's structure or frame that is bent or formed to conform to the proper position for handle 100. The handle is placed around handle section 1010 through centerline 115. In one embodiment, handle 100 is formed in two sections with a channel (not shown) to accommodate handle section 1010. The two sections are placed on either side of handle section 1010 and secured to each other using a mechanical fastener or adhesive. Adjustment is limited since the handle is formed around the handle section. In another embodiment, handle 100 is molded around the handle section 1010.

FIG. 11 illustrates one embodiment of the handle 100 connected to an operational device, in accordance with the present invention. The operational device shown is a power drill 1110 which includes a motor section 1120. Other operational devices may employ handle 100, such as manual hand tools, power hand tools, manual garden tools, power garden tools, and sports equipment.

Motor section 1120 is mounted at an approximate right angle to handle 100. The connection is made at head 120 of the handle. The handle is positioned so pressure applied to the handle is transferred to motor section 1120 while maintaining the hand in a relaxed ergonomically proper position. Handle 100 efficiently transfers the force applied to it since the entire palm surface of the hand is in contact with the handle. The conforming surfaces of the handle prevent undue pressure on any one area of the palm. The placement of the fingers and thumb facilitate reverse or pulling movement of hand in relation to the power drill 1110. Power drill 1110 includes interchangeable handles since handle 100 is specific to left-handed (shown) and right handed users.

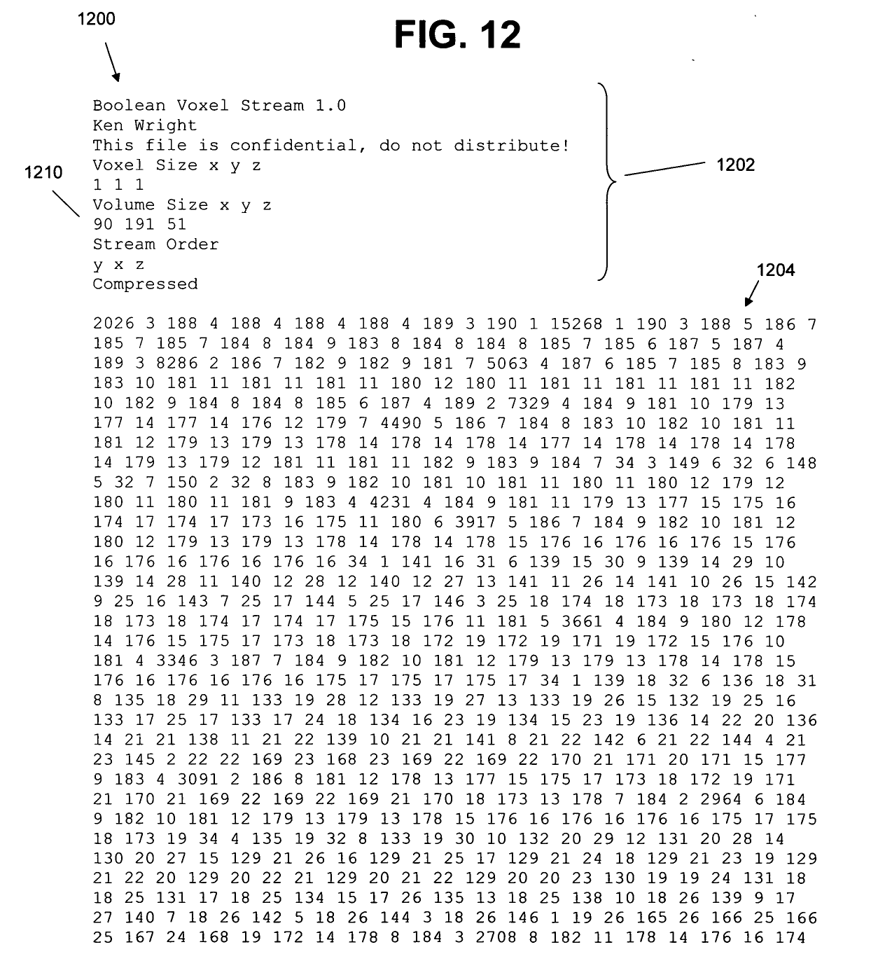

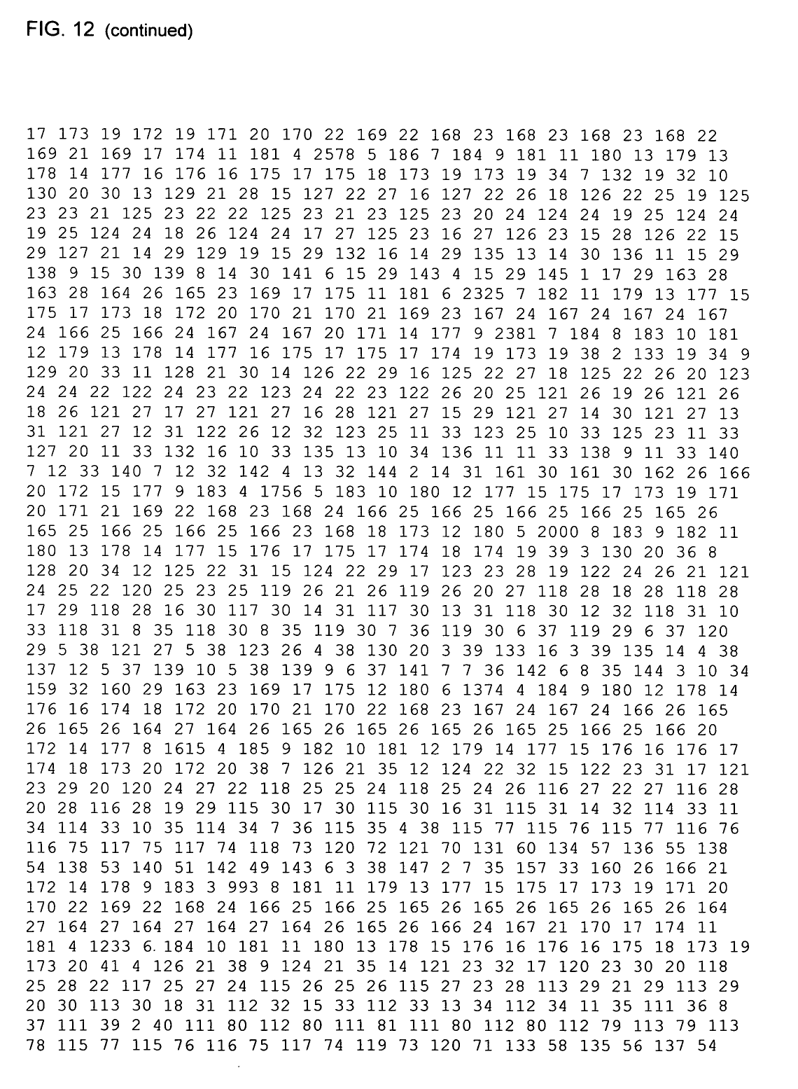

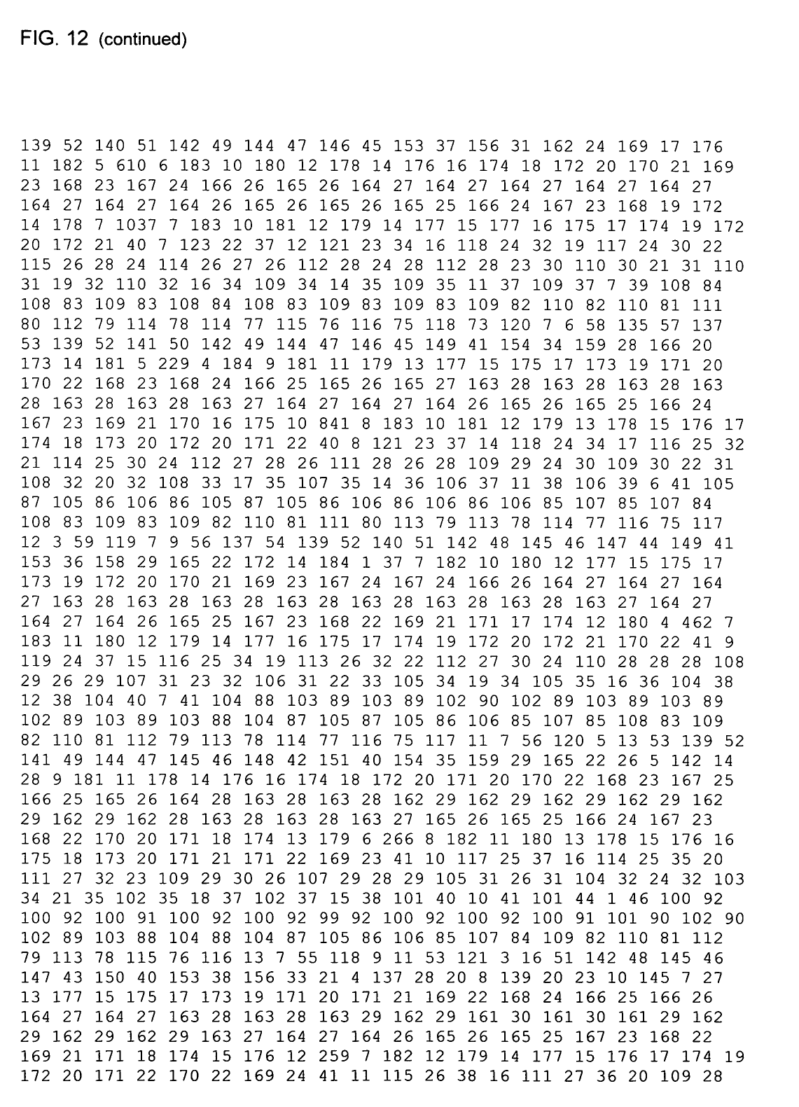

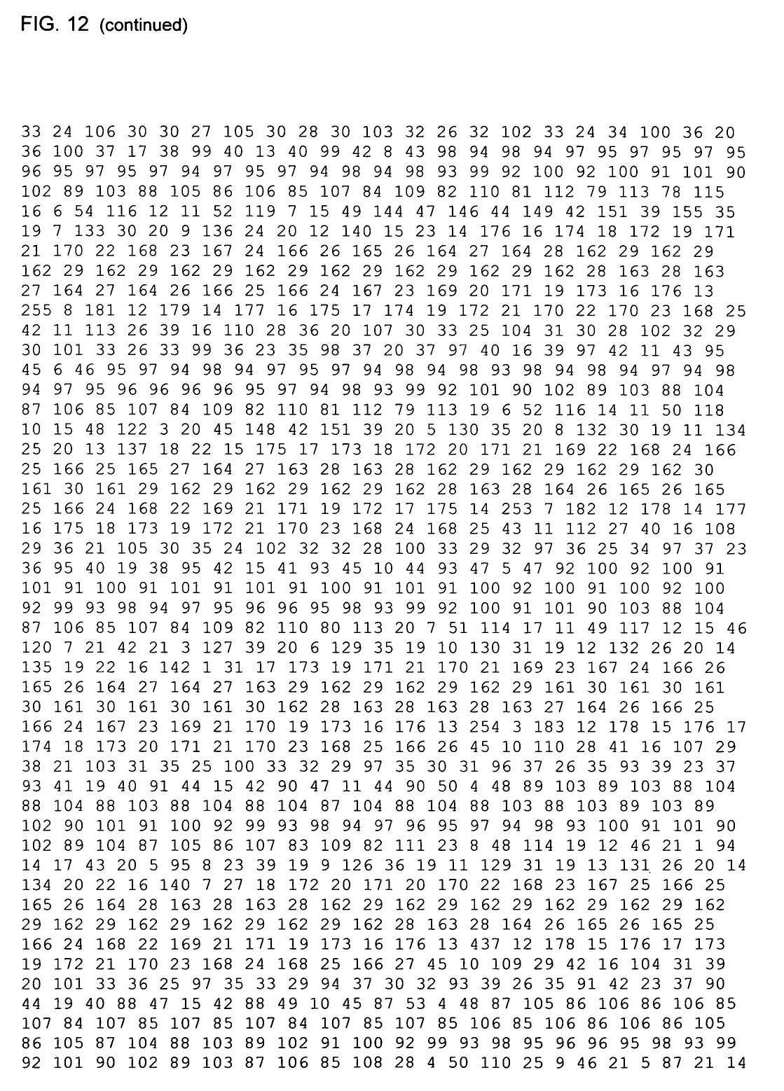

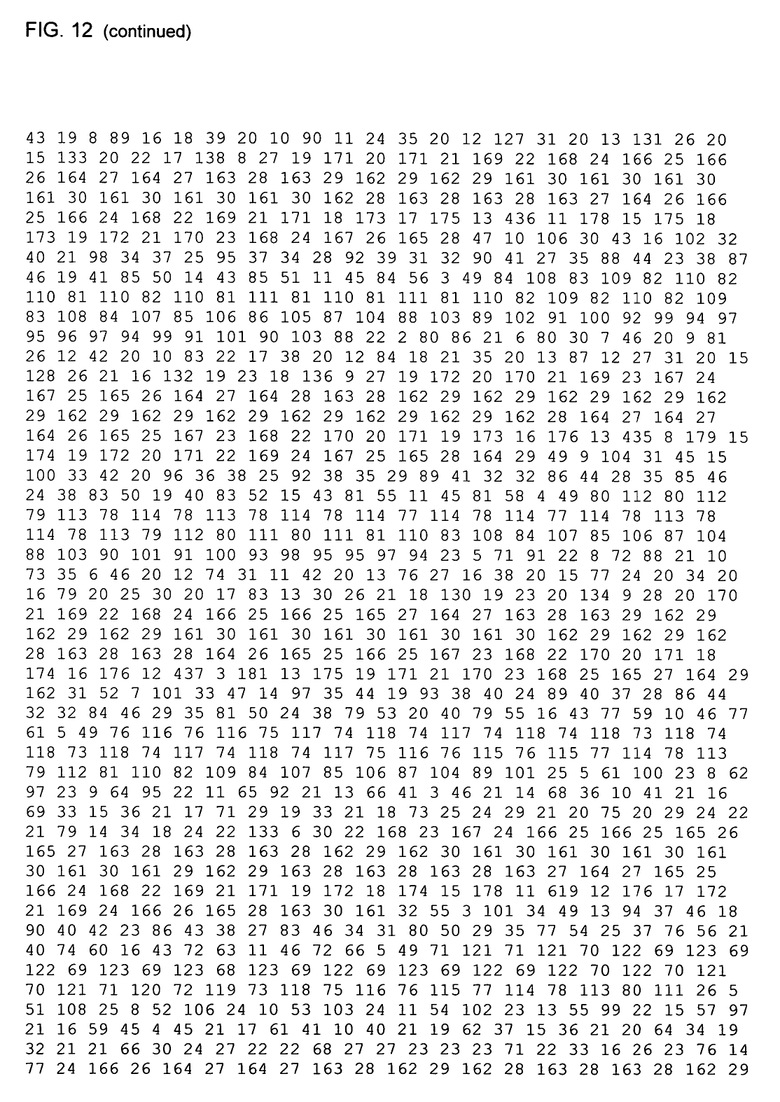

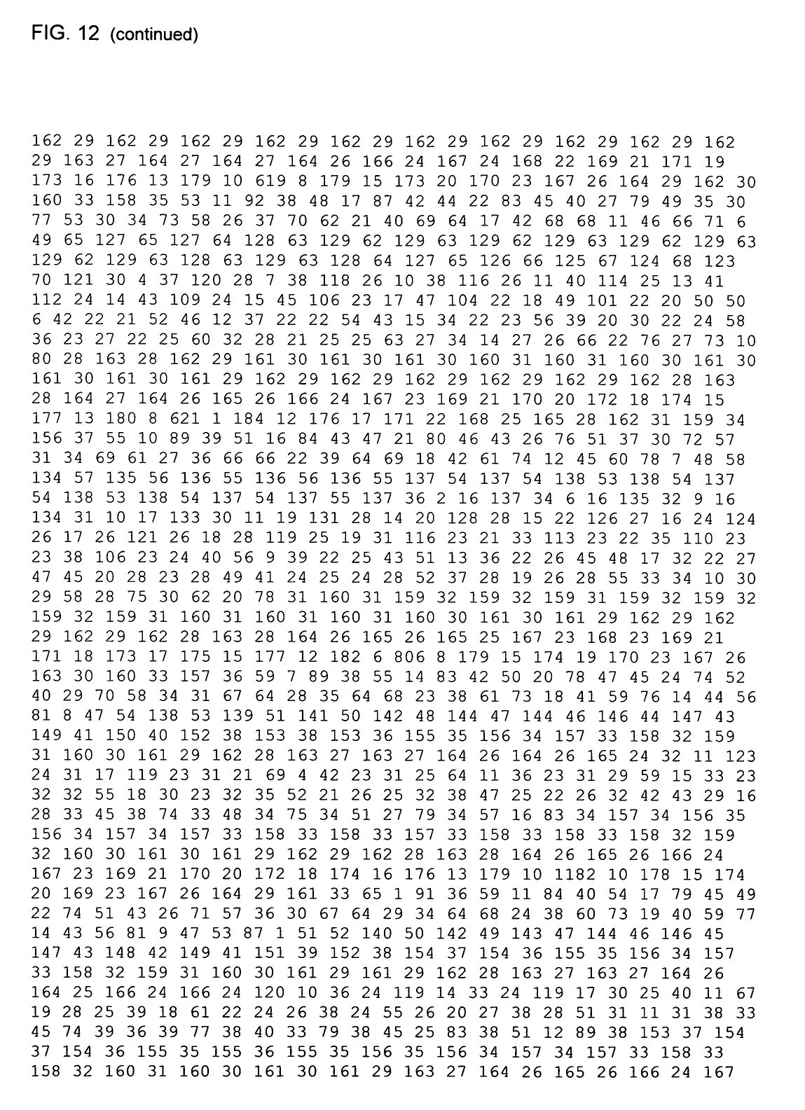

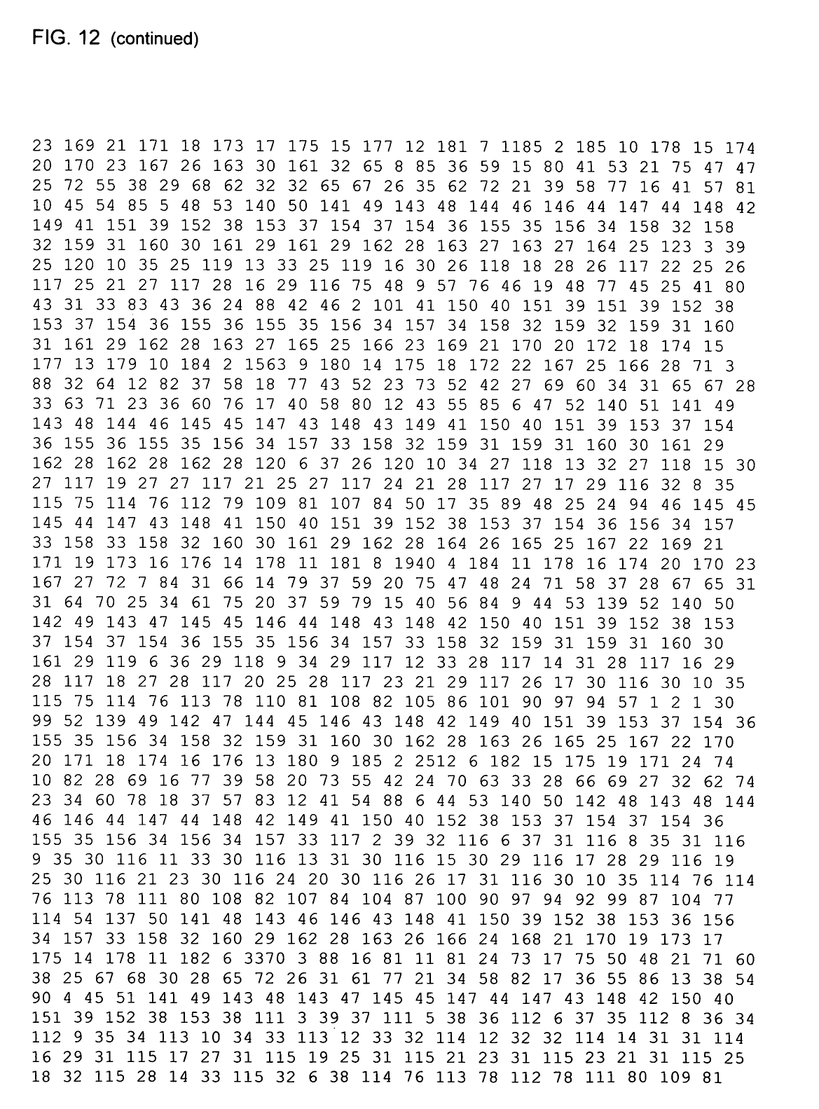

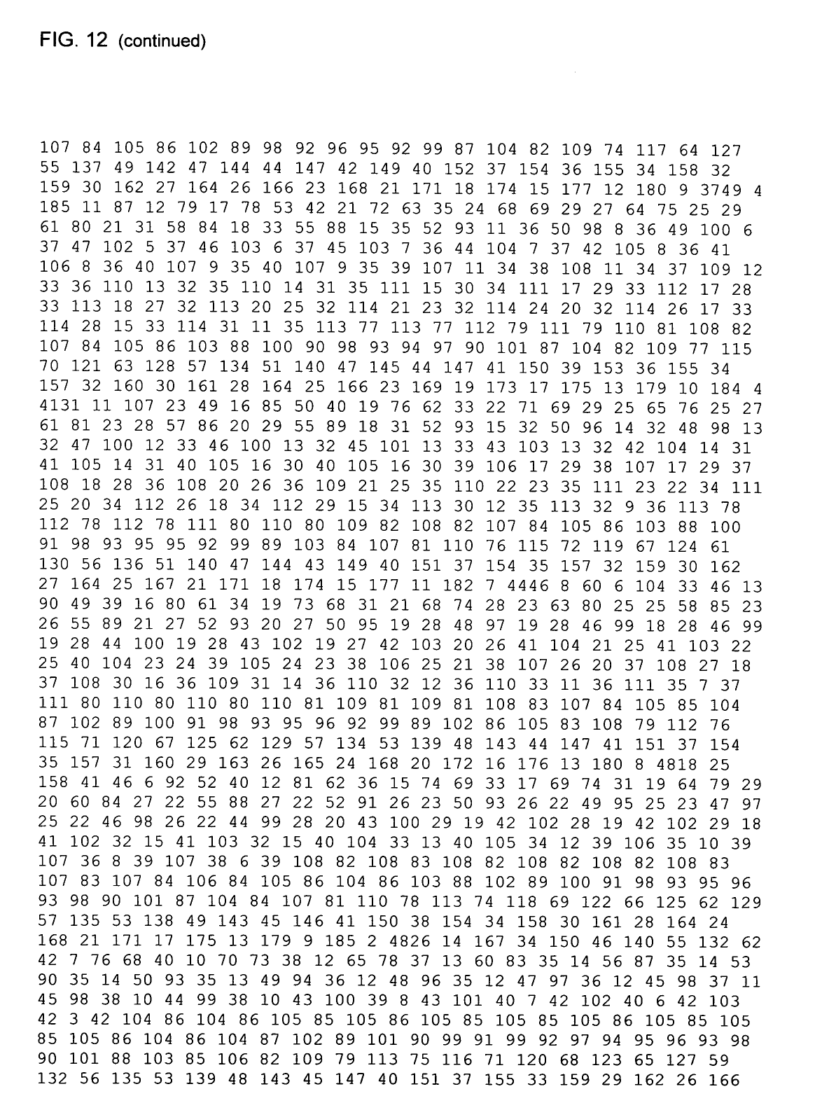

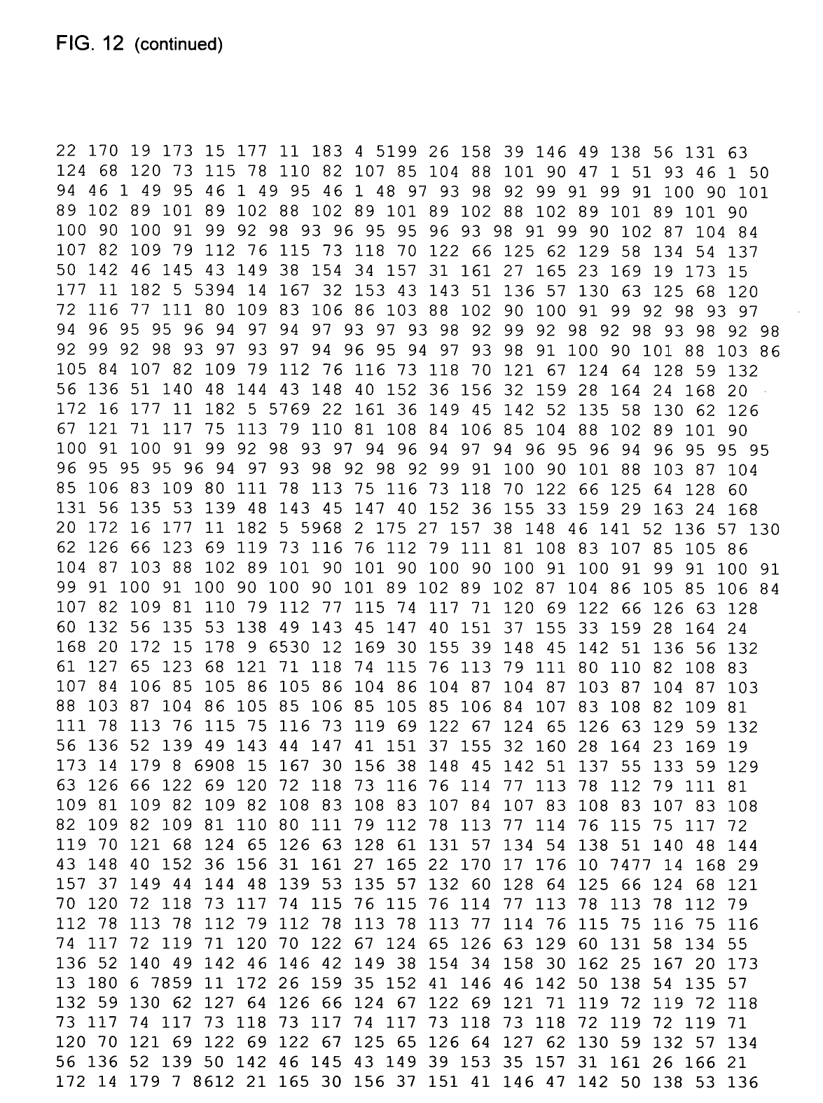

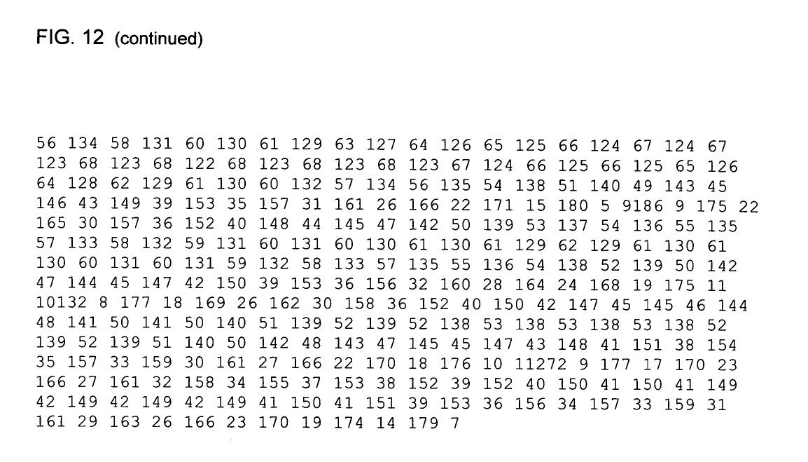

FIG. 12 shows a boolean voxel stream file 1200 representing one embodiment of the handle in accordance with the present invention. The Boolean voxel stream file consists of a header 1202 and a compressed voxel stream 1204 providing a precise description of one embodiment of handle 100 of FIG. 1. Header 1202 contains information relating to voxel stream 1204 that follows it. Header 1202 follows the format requirements described in the preceding discussion and includes volume values 1210. Voxel stream 1204 is read as a single continuous stream of values progressing left to right and top to bottom. Boolean voxel stream file 1200 is used in combination with various three dimensional computer aided drawing programs to generate a solid model of the handle and to provide input for computer aided manufacturing tools.

Boolean voxel stream file 1200 describes a handle that conforms to an average sized hand of an adult male. Boolean voxel stream file 1200 facilitates scaling the handle to accommodate other hand sizes. Scaling is accomplished by increasing or decreasing volume values 1210, by equal percentages or scaling factors. For example, the current volume values are 90, 191, and 51 to decrease the handle size by 10% each value is decreased by 10% so the new volume values would be 81, 171.9, and 45.9.

The handle may also be scaled by differing amounts along each axis by applying different scaling factors to each of the volume values 1210 thereby allowing the handle to be customized for a particular user. The applicable percentages are determined from measurements of the hand relative to the standard sized handle disclosed.

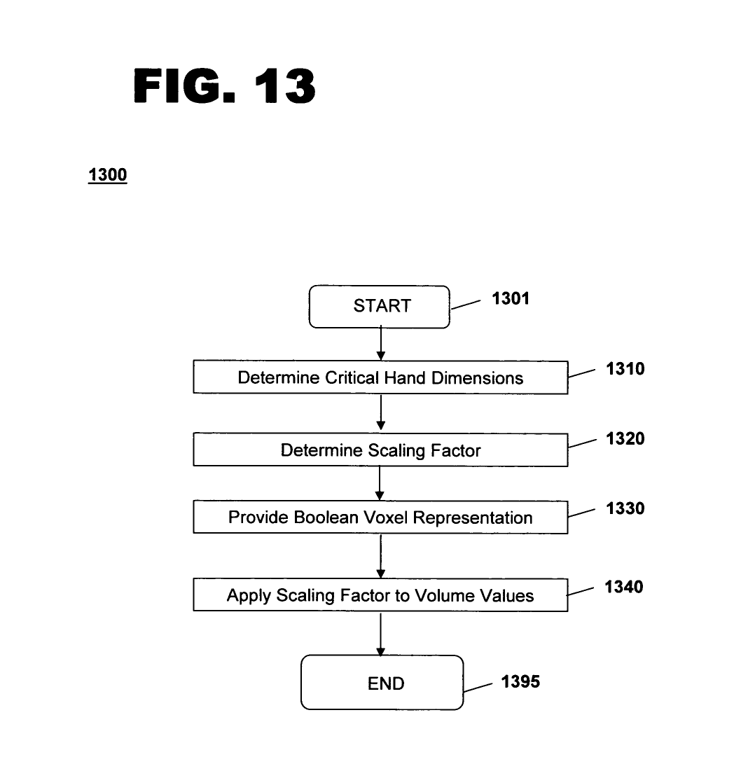

FIG. 13 illustrates a flowchart 1300 representative of one embodiment of a method for sizing the handle, in accordance with the present invention. The method begins at 1301. During step 1310, critical hand dimensions are determined. Critical hand dimensions include palm width, palm height, middle finger length, thumb length, carpal tunnel width and distance from tip of the thumb to tip of the forefinger.

During step 1320, a plurality of scaling factors is determined. The scaling factors are determined by comparing the critical hand dimensions to standard dimensions of the same types listed above. The comparison is used to determine the percentage difference from the standard dimensions and is calculated by dividing the critical dimension by the corresponding standard dimension.

The standard dimensions are based on the average sized hand of an adult male. Palm width is the widest area of the palm, palm height is measured from the wrist to the base of the middle finger, and carpal tunnel width is measured across the palm from the base of the thumb and parallel to the wrist. Additional standard dimensions are included as needed to increase the degree of customization. As the number of dimension types employed increases the degree of customization increases. Standard dimensions are given on the following table:

TABLE OF STANDARD DIMENSIONS

| Dimension type | Dimension (mm) |
|---|---|
| Palm width | 9.7 |
| Palm height | 10.6 |
| Middle finger length | 9.1 |
| Thumb length | 5.6 |
| Carpal tunnel width | 10.5 |
| Thumb/forefinger distance | 17.0 |

During step 1330, a boolean voxel file representation of the handle is provided the boolean voxel file including volume values. The Boolean voxel file is discussed in FIG. 12.

During step 1340, the plurality of scaling factors is applied to the volume values 1210 of the Boolean voxel file 1200 from FIG. 12. The scaling factors allow the manufacture of a custom sized handle based on the critical hand dimensions. To apply the scaling factors, a directional axis corresponding to the x, y, and z axes of the handle is determined for each scaling factor and is assigned as an axis label to the scaling factor. The axis label indicates the direction of measurement along which the scaling factor applies. The x, y, and z axes correspond to the axis references as called out in the header of the Boolean voxel file of FIG. 12 describing the handle.

During step 1395, the method terminates.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A handle comprising:
a substantially flattened cylindrical body having an arching front surface, a substantially planar back surface, a top end and an axially opposed bottom end;
a substantially ellipsoidal head disposed on the top end;
a neck disposed between the head and the body;
a substantially straight first side of the body;
a second side of the body having an extended shoulder adjacent the neck;
A carpal conformity disposed on the front surface of the body substantially parallel to and adjacent the second side; and
a leg disposed at the bottom end and projecting from the back surface.

2. The handle of claim 1 wherein the carpal conformity is of sufficient size to accommodate a superior portion of a palm of a user thereby cradling the superior portion of the palm to prevent excessive compression of the superior portion of the palm.

3. The handle of claim 1 further comprising: a center axis through the top end and extending through the axially opposed bottom end.

4. The handle of claim 1 wherein the neck spirals around the body so that a thumb and a forefinger of a user substantially contact the neck without overlapping.

5. The handle of claim 1 wherein the carpal conformity comprises a folded wing-like structure originating at the extended shoulder and terminating at the bottom end.

6. The handle of claim 1 wherein the head prevents a hand of a user from sliding off the top end and the leg prevents the hand from sliding off the bottom end.

7. The handle of claim 1 coupled to an orthopedic device.

8. The handle of claim 1 further comprising:
a front bracket adjacent the head; and
a rear bracket adjacent the leg, wherein the front bracket and the rear bracket are adjustably connected to a frame of an orthopedic device.

9. The handle of claim 1 further comprising:
connecting means for operably connecting the handle to an orthopedic device.

10. The handle of claim 5 wherein a first angle is defined in a plane parallel to a ground plane between a centerline of the handle and a horizontal centerline of the orthopedic device, and a second angle is defined in a plane perpendicular to the ground plane between the centerline of the handle the horizontal centerline of the orthopedic device.

11. The handle of claim 6 wherein the first angle is approximately 20 degrees.

12. The handle of claim 6 wherein the second angle is approximately 7 degrees.

13. The handle of claim 1 wherein the handle is affixed to a handle section of an orthopedic device, the handle surrounding the handle section.

14. The handle of claim 1 operably coupled to an operational device.

15. The handle of claim 1 wherein the substantially flattened cylindrical body is of a material selected from the group consisting of thermoplastic, wood, nylon, and metal.

16. The handle of claim 1 wherein the substantially flattened cylindrical body is composed of a plurality of materials.

17. A handle coupled to an orthopedic device comprising:
a weight supporting front surface including a carpal conformity wherein support pressure is minimized at a superior portion of a palm of a hand;
a smooth finger contacting back surface comprising a lifting surface for lifting the handle and the coupled orthopedic device;
a top end including a head wherein the head prevents sliding of the hand off the top end; and
a bottom end including a leg wherein the leg prevents sliding of the hand off the bottom end.

18. A method for custom sizing a handle having a plurality of standard dimensions comprising:
determining a plurality of critical hand dimensions;
determining a plurality of scaling factors based on the critical hand dimensions and the standard dimensions;
providing a Boolean voxel representation of the handle, the Boolean voxel representation containing a plurality of volume values; and
applying the scaling factors to the volume values of the Boolean voxel representation.

19. The method of claim 18 wherein determining the plurality of scaling factors comprises: dividing the critical dimension by the corresponding standard dimension.

20. The method of claim 18 wherein applying the scaling factors comprises:
determining a directional axis corresponding to each of the scaling factors;
assigning an axis label each of the scaling factors based on the determined directional axis; and
multiplying the scaling factor by the volume value wherein the scaling factor axis label corresponds to an associated axis of the volume value.
